(19) United States
(12) Patent Application Publication
(10) Pub. No.: US 2003/0139095 A1
(43) Pub. Date: Jul. 24, 2003

(54) Connector

(76) Inventor: Su-Lan Yang Lee, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/337,335

(22) Filed: Jan. 7, 2003

(30) Foreign Application Priority Data
Jan. 22, 2002 (TW) 091200564

(51) Int. Cl. H01R 13/648

(52) U.S. Cl. 439/607

(57) ABSTRACT

A connector comprises a base seat, a terminal main body is snugly fitted in the base seat and a cover body correspondingly latched with rear section of the base seat. A front section of the base seat being formed with a frame section. A rear section of the base seat being formed with a wire seat section. Two side walls of the frame section and the wire seat section integrally continuously extending without any fissure. The terminal main body formed with multiple terminal cavities in which multiple terminals are inlaid. The cover body and the wire seat section of the rear section of the base seat firmly clamp and enclose a lead therein, after assembled, the base seat and the cover body being enclosed by an insulating layer to form a complete connector.

### BACKGROUND OF THE INVENTION

1. Field of the Invention

The present invention is related to a connector in which the base seat has a front frame section and a rear wire seat section. Two side walls of the frame section and the wire seat section integrally continuously extend so as to prevent stress from concentrating on the adjoining section between the frame section and the wire seat section and avoid bending and deformation. The terminal main body of the connector is firmly clamped and located by the base seat and a cover body.

2. Description of the Prior Art

FIGS. 5 and 6 show a computer-used connector. The plug of the connector has a terminal main body B and a pair of shielding casings for accommodating the terminal main body B. The shielding casings include a base seat S1 and a cover body S2. The front section of the base seat S1 is formed with a T-shaped frame section S11. The rear section of the base seat S1 is formed with a wire connecting section S12. When assembled, the front end of the terminal main body B is fitted in the frame section S11 of the base seat. A first interference section 343 of the front end of the terminal main body B abuts against a projecting section 362 in the frame section S11. In assembly and application, the conventional connector has some shortcomings as follows:

1. As shown in FIGS. 5 and 6, a fissure S13 is formed on the side wall of a section of the base seat S1 adjoining the front frame section S11 with the rear wire connecting section S12. When transferred or assembled, in the case that the base seat S11 suffers external force F, the stress is likely to concentrate at the fissure S13. As a result, the base seat S1 tends to bend and deform at the fissure S13 to form a wasted product.

2. Only the front end of the terminal main body B abuts against the base seat S1. The rear side of the terminal main body B is without any support of other element. Therefore, the terminal main body B is likely to slip or retreat.

### SUMMARY OF THE INVENTION

It is therefore a primary object of the present invention to provide a connector including: a base seat, a front section of the base seat being formed with a frame section, a rear section of the base seat being formed with a wire seat section, two side walls of the frame section and the wire seat section integrally continuously extending so as to prevent stress from concentrating on the adjoining section between the frame section and the wire seat section and avoid bending and deformation; a terminal main body formed with multiple terminal cavities in which multiple terminals are inlaid, at least one projecting section being formed on outer side of the terminal main body, whereby when the front section of the terminal main body is correspondingly fitted into the frame section of the base seat, the projecting section abuts against an outer edge of a stopper shoulder of the base seat; and a cover body correspondingly latched with rear section of the base seat, whereby the cover body and the wire seat section of the base seat firmly clamp and enclose a lead therein. At least one support plate projects from the cover body for abutting against rear side of a stopper shoulder of the terminal main body so as to firmly clamp and locate the terminal main body.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a perspective view of the present invention, showing that the base seat and the cover body are enclosed by an insulating layer;

FIG. 4 is a side view of the base seat of the present invention;

FIG. 5 is a side view of the base seat of a conventional connector; and

FIG. 6 is a perspective exploded view of the conventional connector.

### DETAILED DESCRIPTION OF THE PREFERRED EMBODIMENT

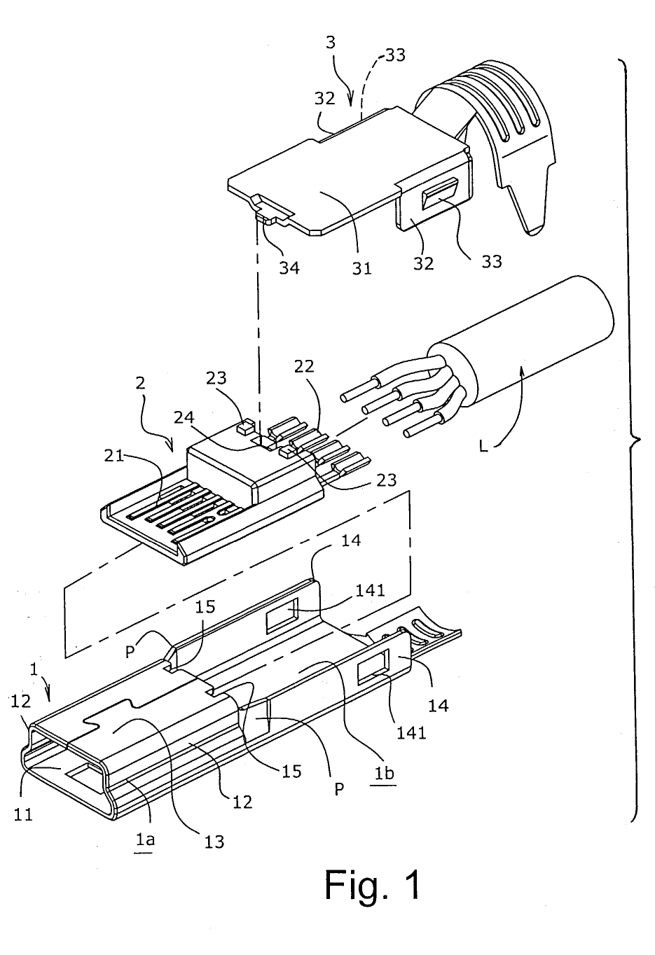

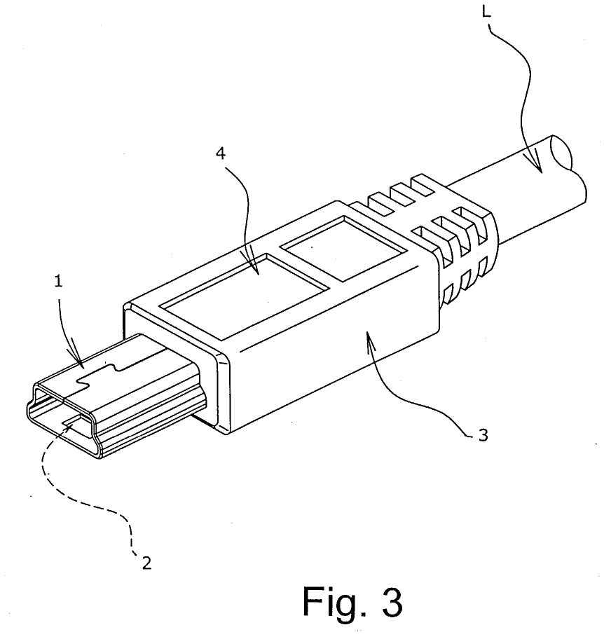

Please refer to FIGS. 1 to 4. The connector of the present invention includes a base seat 1; a terminal main body 2 in which multiple terminals 22 are inlaid, the terminal main body 2 being snugly fitted in the base seat 1; and a cover body 3 correspondingly latched with rear section of the base seat 1 to enclose a lead L therein. The cover body 3 and the base seat 1 tightly clamp the terminal main body 2. After assembled, the base seat 1 and the cover body 3 are enclosed by an insulating layer 4 to form a complete connector.

Referring to FIGS. 1 to 4, the base seat 1 is made of a metal board and has a base board 11. Two side walls 12 respectively upward windingly extend from two sides of front section of the base board 11. The top ends of the side walls 12 oppositely radially extend to latch with each other to form a top board section 13 and define a T-shaped frame section 1a. Two side walls 14 respectively upward integrally extend from two sides of rear section of the base board 11. The side walls 14 and the base board 11 define a wire seat section 1b on which the lead L is rested. The side walls 14 of the wire seat section 1b integrally continuously extend from the two side walls 12 of the frame section 1a. Accordingly, when the base seat 1 suffers an external force, the stress is prevented from concentrating on the adjoining section P between the frame section 1a and the wire seat section 1b so as to avoid bending and deformation.

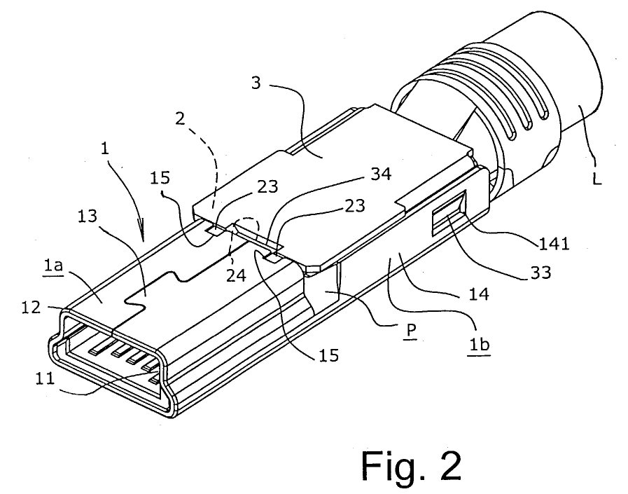

Referring to FIGS. 1 and 2, the terminal main body 2 is formed with multiple terminal cavities 21 in which multiple terminals 22 are inlaid. At least one projecting section 23 is formed on outer side of the terminal main body 2. When the front section of the terminal main body 2 is correspondingly fitted into the frame section 1a of the front section of the base seat 1, the projecting section 23 abuts against an outer edge 15 of a stopper shoulder of the base seat 1.

The cover body 3 is made of metal board and has a board section 31. Two side walls 32 respectively downward integrally extend from two sides of the board section 31. Each side wall 32 has at least one outward projecting latch hook 33 which is correspondingly hooked in latch hole 141 of the side wall 14 of the wire seat section 1b. In addition, at least one support plate 34 projects from front edge of the cover body 3. When the cover body 3 is correspondingly latched with the base seat 1, the support plate 34 abuts against rear side of a stopper shoulder 24 of the terminal main body 2. Accordingly, the terminal main body 2 is firmly clamped and located by the support plate 34 and the outer edge 15 of the stopper shoulder of the base seat 1.

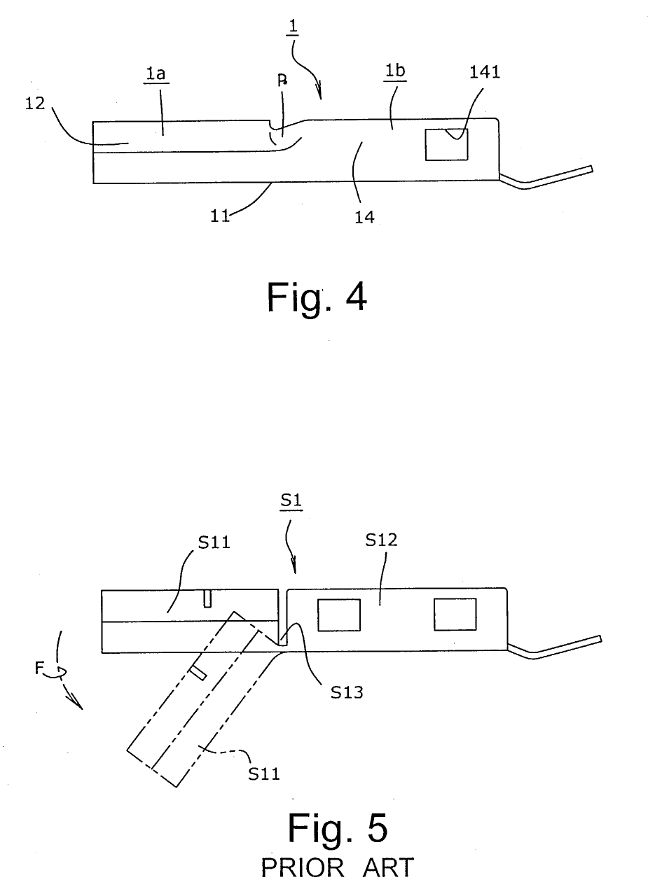

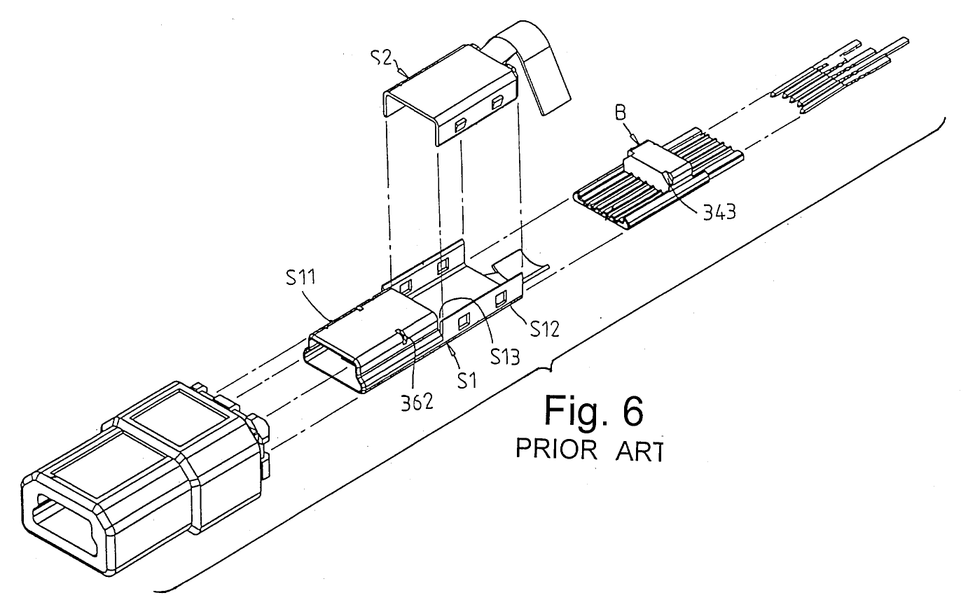

Referring to FIG. 4, the side walls 12, 14 of the frame section 1a and wire seat section 1b of the base seat 1 are integrally formed at the adjoining section P between the frame section 1a and the wire seat section 1b without any fissure. Therefore, when suffering external collision force such as in transferring or assembling procedure, the stress is prevented from concentrating on the adjoining section P between the frame section 1a and the wire seat section 1b so as to avoid bending and deformation of the base seat 1 at the adjoining section P. Moreover, the terminal main body 2 is clamped by the stopper shoulder 15 of the base seat 1 and the support plate 34 of the cover body 3 from front side and rear side so that the terminal main body 2 is firmly located without swinging.

The above embodiment is only used to illustrate the present invention, not intended to limit the scope thereof. Many modifications of the above embodiment can be made without departing from the spirit of the present invention.

What is claimed is:

1. A connector comprising:
(a) a base seat, a front section of the base seat being formed with a frame section, a rear section of the base seat being formed with a wire seat section, two side walls of the frame section and the wire seat section integrally continuously extending without any fissure;
(b) a terminal main body formed with multiple terminal cavities in which multiple terminals are inlaid, the terminal main body being snugly fitted in the base seat; and
(c) a cover body correspondingly latched with rear section of the base seat, whereby the cover body and the wire seat section of the rear section of the base seat firmly clamp and enclose a lead therein, after assembled, the base seat and the cover body being enclosed by an insulating layer to form a complete connector.

2. The connector as claimed in claim 1, wherein at least one projecting section is formed on outer side of the terminal main body, whereby when the front section of the terminal main body is correspondingly fitted into the frame section of the front section of the base seat, the projecting section abuts against an outer edge of a stopper shoulder of the base seat.

3. The connector as claimed in claim 1, wherein the cover body has a board section, two side walls respectively downward integrally extending from two sides of the board section, each side wall having at least one outward projecting latch hook which is correspondingly hooked in latch hole of the side wall of the wire seat section of the base seat.

4. The connector as claimed in claim 1, wherein at least one support plate projects from front edge of the cover body, whereby when the cover body is correspondingly latched with the base seat, the support plate abuts against rear side of a stopper shoulder of the terminal main body so that the terminal main body is firmly clamped and located by the support plate and the outer edge of the stopper shoulder of the base seat.
